(19) United States
(12) Patent Application Publication
(10) Pub. No.: US 2025/0162797 A1
(43) Pub. Date: May 22, 2025

(54) Modular Warehouse Installation Device

(71) Applicants: Kardex AS Solutions AG, Zurich (CH); Kardex Solutions LLC, Cincinnati, OH (US)

(72) Inventors: Marco Pfendsack, Muhen (CH); Joshua Johnson, Charlotte, NC (US)

(21) Appl. No.: 18/517,313

(22) Filed: Nov. 22, 2023

(51) Int. Cl. B65G 1/04; G01B 5/02

(52) U.S. Cl. CPC B65G 1/04; G01B 5/02

(57) ABSTRACT

Modular warehouse installation device for initial filling of an automated warehouse with a plurality of storage bins comprising a plurality of transportable modules. The plurality of transportable modules comprising at least a transportable testing gauge module and a scanning module. The transportable testing gauge module comprising a testing assembly that is configured to determine a deviation of a shape of any storage bin of the plurality of storage bins from a predetermined standard shape and generate a gauge signal dependent on the determined deviation. The transportable scanning module comprises a label scanner with a field of view that is configured to output an identification signal dependent on a label in the field of view and located on any storage bin of the plurality of storage bins. The plurality of transportable modules are configured to be assembled in any order.

### FIELD OF INVENTION

The present invention relates to a modular warehouse installation device for initial filling of an automated warehouse with a plurality of storage bins comprising a plurality of transportable modules that are configured to be assembled in any order.

### BACKGROUND

Most automated warehouse systems work with dedicated bins to store goods and products. To properly operate an automated warehouse, these bins need to be registered and stored in the system before using them for the first time. Extensive processes are required before the automated warehouse can be fully operated. These processes are time-consuming and error-prone.

Therefore, there is a need to facilitate the automation of the initial installation of an automated warehouse, in which the process of setting up automated warehouses is improved.

### SUMMARY

This object is achieved by a modular warehouse installation device for initial filling of an automated warehouse with a plurality of storage bins, wherein the modular warehouse installation device comprises a plurality of transportable modules, the plurality of transportable modules comprising at least a transportable testing gauge module comprising a testing assembly that is configured to determine a deviation of a shape of any storage bin of the plurality of storage bins from a predetermined standard shape and generate a gauge signal dependent on the determined deviation; and a transportable scanning module comprising a label scanner, the label scanner having a field of view and being configured to output an identification signal dependent on a label in the field of view and located on any storage bin of the plurality of storage bins, wherein the transportable modules are configured to be assembled in any order.

The above solution is advantageous, as it reduces costs and time needed to set up an automated warehouse. Less personnel is needed when the above solution is used. Because the device is transportable, it can be reused each time a new automated warehouse system is set up. A further advantage is the modularity of the system in combination with its mobility, making it easily adjustable to different installation surroundings and requirements and accommodating different needs of the initial filling such as different orders of processes.

The invention can be further improved by the following embodiments which are advantageous in themselves and which can be arbitrarily combined with one another. The modular warehouse installation device may comprise a plurality of transportable, in particular mobile modules.

An embodiment may comprise at least one transportable conveyor module comprising a transportation line. The transportation line may have a distal end and a proximal end and configured to movably support at least one storage bin of the plurality of storage bins. The conveyor module may be configured to guide the at least one storage bin from the proximal end to the distal end.

The at least one transportable conveyor module may comprise a height adjustment assembly. The height adjustment assembly may be configured to adjust the height of the transportation line, which enables accessibility, ergonomic usage to meet the needs of various users, and an accommodation to different tasks, preferences and/or working arrangements, adapting to different environments. In particular, the height adjustment assembly may be used to adjust the height to the same height as another module, for example to adjust its height to the same height as the transportable testing gauge module. The height adjustment assembly may be used to be adjusted to the same height as the transportable scanning module. It may also be used to be adjusted to another transportable conveyor module. It is also conceivable to adjust the height of the at least one transportable conveyor module to a storage bin feeding port of the automated warehouse. The height adjustment assembly may comprise a drive assembly to adjust the height. The drive assembly may comprise a motor.

The at least one transportable conveyor module may comprise an inclination adjustment device configured to adjust a height difference between the proximal end and the distal end of the transportation line. With the inclination adjustment device the at least one transportable conveyor module may be tilted at an angle that enables a bin to be transported from the proximal end to the distal end of the transportation line by sliding along the transportation line by gravitational force. This embodiment is advantageous as there would be no need to use electrical means like motors to move the transportation line or bins. It is also possible to use the inclination adjustment device to overcome a height difference and aid a motor-driven transportation line. The distal end may be higher than the proximal end. The transportation line may also be adjusted during transportation to adjust to any height differences.

The at least one transportable conveyor module may further comprise a drive assembly configured to move at least one storage bin from the proximal end to the distal end. This can be done actively by the at least one transportable conveyor module. The drive assembly may comprise a conveyor belt. The drive assembly may also comprise driven rolls or a combination of conveyor belt and driven rolls. With this advantageous embodiment height differences where the distal end is higher than the proximal end may be overcome. It also enables the automatic transportation of the bin without human intervention and contributes to a faster and consistent transportation of the bins.

In another advantageous embodiment, the transportable conveyor module comprises a control unit. The control unit comprises a data interface that is adapted to be connected to a matching data interface of the automated warehouse to control the drive assembly dependent on data received from the automated warehouse via the data interface. In particular, the drive assembly can be adjusted to match the timing of the internal processing of the automated warehouse system. For example, it can be matched to the timing of robots picking up and storing the bins, optimizing the insertion of bins to the robots' rate to pick up and store bins, and thus increasing the tempo of filling the automated warehouse. The control unit may also be used to prevent overloading the automated warehouse system, for example should the robot not be able to pick up a bin in time or should the automated warehouse system be full. This can be fully automated and does not require the attention of an overseer.

The transportation line of the transportable conveyor module may transport the bin directly to a storage bin feeding port of the automated warehouse. The transportation line may for example transport the bins to an existing conveyor module of the automated warehouse, which may be located past the storage bin feeding port inside the automated warehouse. The existing conveyor module may also be located outside the automated warehouse, directly in front of the storage bin feeding port.

The distal end of the transportation line may be configured as a mechanical interface that connects to the storage bin feeding port or the existing conveyor module of the automated warehouse for passing the storage bin from the transportation line to an internal conveying system of the automated warehouse. This way, the advantageous embodiment is directly connected to the automated warehouse and able to directly feed bins to the automated warehouse, rendering the manual insertion of bins unnecessary.

The transportable testing gauge module may comprise a transportation line being configured to movably support at least one storage bin of the plurality of storage bins. After gauging the bin, the bin may be directly transported on to the next module or the port module of the automated warehouse system, ensuring a continuous and seamless feeding to the automated warehouse.

The transportable testing gauge module may further comprise a drive assembly configured to move at least one storage bin from the proximal end to the distal end. The transportable testing gauge module may further comprise a control unit comprising a data interface that is adapted to be connected to a matching data interface of the automated warehouse and to control the drive assembly dependent on data received from the automated warehouse via the data interface. This embodiment has the advantage of controlling and adjusting the feeding tempo from the start and having the possibility to signal to the personnel in time if the filling of the bins needs to be paused, avoiding additional work of installers in the process when not needed.

Alternatively, the transportable testing gauge module can be configured to be placed at the side of the transportation line of the at least one transportable conveyor module. This reduces the size of this particular embodiment of the modular installation device and increases the flexibility and modularity to adapt to the environment. The set-up can be sped up and the de-installation includes less effort and less large parts to be carried or demounted after the filling of the automated warehouse is done.

The testing assembly may comprise a lifting assembly, a frame and a gauge mounted to the frame. The lifting assembly may be configured to lower the frame to the storage bin on the transportation line of the transportable testing gauge module. The frame can be lowered to a gauging zone of the transportation line. The gauge signal may depend on a lowered position of the frame.

The gauge signal may be a visual, acoustic and/or electronic signal. The gauge signal may also be a visual deviation the user perceives, when the bin and the gauge do not fit together, for example when the gauge recognizably does not match the storage bin, especially the upper edge of the storage bin and/or when the gauge cannot be lowered to the storage bin, especially the edge of the storage bin. The gauge signal can comprise lamps or sounds, so that during lowering, different colors on a scale are made visible to indicate the conformity of the bin to be gauged.

The gauge may be shaped complementary to the upper edge of the predetermined standard shape of the storage bins. The gauge may be used to gauge the dimensions of the storage bin. It may also be used to check the dimensions and spacing of connecting elements of the storage bin to be connected to complementary connecting elements of the automated warehouse system. This embodiment provides a perceptible, tactile feedback to the user to immediately tell the suitability of the storage bin being gauged.

The lifting assembly may be automated and/or manual. The lifting assembly can be automated with a drive system. It can be manually operated by using a self-retracting support. The self-retracting support may comprise a spring element to automatically move the gauge to the gauge's initial position, where it is ready to check again, after it has been displaced for gauging a bin. The self-retracting support may comprise a drive assembly to move the gauge.

Alternatively or cumulatively the lifting assembly may comprise a camera with an image processing device. The image processing device may be a software or hardware and is configured to determine the deviation of the shape of the bin. The image processing device may be part of the control unit of the automated warehouse. The image processing device may be part of the transportable testing gauge module. This allows for a fully automated gauging of the bin where the user only needs to put the bin to where it can be gauged and does not need to further engage with the device for the bin to be gauged. The transportable testing gauge assembly may comprise a data interface that is adapted to be connected to a matching data interface of the automated warehouse and that is furthermore connected to the camera. The gauge signal and/or height may be sent to the automated warehouse via the matching data interface. The data processing of the images may be done with the data interface of the transportable testing gauge assembly. The data processing may also be done at the matching data interface of the automated warehouse, where the raw images captured may be sent to the automated warehouse via the matching data interface.

The transportable testing gauge assembly may be configured to determine a height of the storage bin. The transportable testing gauge assembly may be configured to generate a height signal representative of the height of the storage bin. This allows for the use of different sized bins within the system and the full identification thereof.

Alternatively or cumulatively the transportable testing gauge assembly may comprise a camera with an image processing device, the image processing device may be a software or a hardware being configured to determine the deviation of the shape of the storage bin from the standard shape and/or the height of the storage bin. It may further comprise a data interface that is adapted to be connected to a matching data interface of the automated warehouse and that is connected to a camera. The gauge signal and/or height may be sent to the automated warehouse via the matching data interface.

The transportable scanning module may comprise a data interface that is adapted to be connected to a matching data interface of the automated warehouse. The data interface may be further adapted to transmit data representative of a scanned label via the matching data interface to the automated warehouse, in particular to a warehouse management software of the automated warehouse. The transportable scanning module may comprise a camera to capture a unique identifier of the storage bin.

In another advantageous embodiment the transportable scanning module comprises a transportation line being configured to movably support at least one storage bin of the plurality of storage bins. The transportable scanning module may comprise a drive assembly configured to move at least one storage bin from the proximal end to the distal end. The drive assembly may move the at least one storage bin actively. The transportable scanning module may further comprise a data interface that is adapted to be connected to a matching data interface of the automated warehouse to control the drive assembly of the transportation line.

In an alternative embodiment the transportable scanning module is configured to be placed at the side of the transportation line of the at least one transportable conveyor module. The field of view may be directed to the transportation line of the transportable scanning module.

The plurality of transportable modules may comprise at least two transportable conveyor modules, wherein the distance between the distal end and the proximal end is different in each of the at least two different conveyor modules for more flexibility in the installation and the efficient utilization of space. At least one transportable conveyor module may comprise a transportation line of adjustable length. It can be designed to be telescoped or designed as an insertable or addable section of the transportation line which contributes to the modularity of the individual modules.

A transportable conveyor module may be used as a buffer for temporarily storing storage bins. The transportable conveyor module may be used as a buffer between any two members of the group comprising the transportable testing gauge module, transportable labelling module and/or the transportable scanning module to control the flow and speed of filling the storage bin feeding port of the automated warehouse.

The transportable modules may further comprise a labelling module which comprises a labelling assembly configured to label a storage bin to uniquely identify the storage bin and/or provide data for the transportable scanning module and/or the automated warehouse system.

The labelling module may be configured to attach a printed label on a storage bin and/or to print a label directly on a storage bin by engraving via laser or printing, the engraving providing a more durable option than printing, while the printing provides a more versatile and adjustable approach.

The labelling module may comprise a transportation line being configured to movably support at least one storage bin of the plurality of storage bins.

The labelling module may comprise a drive assembly configured to move at least one storage bin from the proximal end to the distal end. The drive assembly may move the at least one storage bin actively. The labelling module may further comprise a data interface that is adapted to be connected to a matching data interface of the automated warehouse to control the drive assembly of the transportation line.

An alternative embodiment of the labelling module may be configured to be placed at the side of the transportation line of the at least one transportable conveyor module.

The labelling assembly may be located above the transportation line. The labelling assembly may be configured to label a storage bin on the transportation line, it may be configured to label a storage bin on a labelling zone of the transportation line.

The transportable modules may be configured as carts. At least one cart may comprise a drive assembly for driving the cart and/or configured to be pushed manually, reducing the manual force needed to transport the modules.

In another embodiment the transportable modules may be on a pedestal and are configured to be lifted by a forklift vehicle, easing the transport and installation of the modules.

The invention shall be explained in more detail hereafter by way of example with reference to the drawings. The feature combinations illustrated in the embodiments shown by way of example can be supplemented by further features in accordance with the above statements in correspondence with the properties of the invention required for a specific application. Individual features can also be omitted in accordance with the above statements from the embodiments described if the effect of these features is of no relevance for a specific application. The same reference numerals in the drawings are always used for elements having the same function and/or the same structure.

### BRIEF DESCRIPTION OF THE DRAWINGS

FIG. 1 shows an embodiment of the modular warehouse installation device;

FIG. 2 shows an embodiment of the transportable testing gauge module;

FIG. 3 shows a schematic depiction of the modular warehouse installation device with a transportable labelling module;

FIG. 4 shows a schematic depiction of the modular warehouse installation device with separate transportable testing gauge module and transportable scanning module; and

FIG. 5 shows the modular warehouse installation device with the different modules placed on the side of a transportation line.

### DETAILED DESCRIPTION

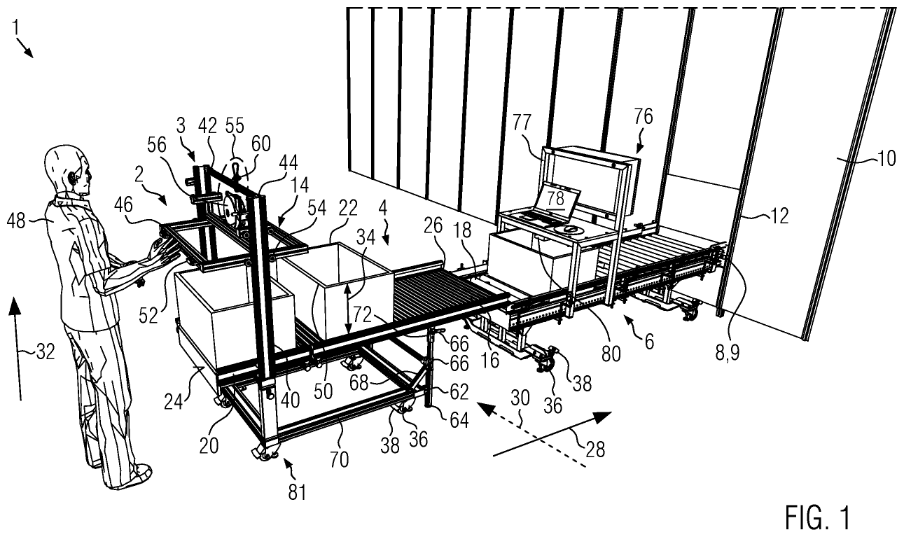

FIG. 1 shows the modular warehouse installation device 1 with a transportable testing gauge module 2 comprising a testing assembly 3 and a transportable conveyor module 4. The modular warehouse installation device 1 further comprises a transportable scanning module 6 that has a distal end 8 that is connected to the automated warehouse 10, specifically to a storage bin feeding port 12 of the automated warehouse 10. The distal end 8 can be or have a mechanical interface 9 for the purpose of connecting to the automated warehouse 10.

The testing assembly 3 comprises a frame 14. The testing assembly 3 may also comprise a transportation line 16 that continues to the transportation line 16 of the transportable conveyor module 4. The transportation line 16 may comprise a conveyor belt, a conveyor chain or rolls 18. The transportation line 16 of the transportable testing gauge device 2 comprises a raised border 20 that is raised on two sides of the storage bin 22 to guide the storage bin 22 from a proximal end 24 to a distal end 26 of the transportation line 16 and to keep the storage bin 22 from falling off the transportation line 16. The border 20 may be an integral part of the transportation line 16 or added later on via screwing. In FIG. 1 the border 20 is formed along the direction of transportation 28, which is the direction towards the automated warehouse 10. The rolls 18 are formed perpendicular to the direction of transportation 28 in a direction 30 and are installed in a way that allows free rotation of the rolls 18 around an axis of direction 30, perpendicular to the direction of transportation 28, i.e. with bearings. The borders 20 are raised in a direction 32 perpendicular to both directions 28, 30, along the height 34 of the storage bin 22.

The transportable testing gauge device 2 may comprise wheels 36 with which the transportable testing gauge device 2 can be relocated with minimal force and effort. The wheels 36 may comprise brakes 38 that can be engaged to fix the testing gauge device 2 in place, when the ideal position of the transportable testing gauge device 2 has been found.

The testing assembly 3 comprises two beams 40 that are each designed to be attached from outside to each border 20 of the transportation line 16. The beams 40 rise along the direction 32 of the height 34 of the storage bin 22 with a connecting bar 42 on the upper ends 44 further along the direction 32 of the height 34 of the beams 40.

Furthermore, the testing assembly 3 comprises a gauge 46 mounted to the frame 14 to gauge the dimensions of the storage bin 22. The testing assembly 3 can be configured to allow the lowering of the frame 14, in particular where the gauge 46 is mounted on. The lowering can be done manually by a pulling action of a user 48, by the gauge's 46 own weight or by a drive assembly. The gauge 46 mounted to the frame 14 is ideally lowered to the edge 50 of the storage bin 22. The frame 14 may comprise U-shaped elements 52 attached to the side facing the user 48 that can be used to lower the gauge 46 mounted to the frame 14 down to the edge 50 of the storage bin 22.

The testing assembly 3 comprises sliding rolls 54 that are arranged in pairs and attached to the frame 14, each pair of sliding rolls 54 facing one of the two beams 40 of the testing assembly 3. The sliding rolls 54 are installed in a way that the beam 40 is arranged between two sliding rolls 54, enabling the sliding rolls 54 to roll along the direction 32 along the sides of the beam 40. On each beam 40 of the testing assembly 3, four sliding rolls 54 enable the frame 14 with the mounted gauge 46 to be slid along the beam 40.

The testing assembly 3 further comprises a lifting assembly 55 with a lifting element 56 that is attached to a support section 58 attached to the gauge 46 and/or to the frame 14 where the gauge 46 is mounted on to enable a lifting action of the frame 14 with the gauge 46. The lifting action of the testing assembly 3 with the gauge 46 may be done manually by lifting the frame 14 with the gauge 46. The frame 14 with the gauge 46 may also be lifted by the lifting assembly 55. The lifting assembly 55 may comprise a spring element that has been loaded by lowering the frame 14 with the gauge 46 beforehand. The lifting assembly 55 may also comprise a drive assembly to move the frame 14 with the gauge 46 up and down. The support section 58 is attached to the upper side of the gauge 46 and/or to the upper side of the frame 14 where the gauge 46 is mounted on and extends from one side of the frame 14 facing the beam 40 of the testing assembly 3 to the other side facing the other beam 40. The support section 58 may be used to attach the sliding rolls 54. The lifting assembly 55 may have a stationary element 60 attached to the connecting bar 42 of the testing assembly 3, to which the lifting element 56 may be connected to via a wire or spring element (not shown in the drawing) and is used to pull the gauge 46 to its initial position after the storage bin 22 has been gauged. This can be done manually, with the user 48 pulling the gauge 46 and/or the frame 14 with the mounted gauge 46 down and the lifting element 56 pulling the gauge 46 and/or the frame 14 with the mounted gauge 46 back up. This can also be done automatically with a drive system and sensors attached to the gauge 46 and/or the frame 14.

In this embodiment, the transportable conveyor module 4 is depicted as part of the transportable testing gauge module 2 and uses the same wheels 36 to be transported to the installation location. The transportable conveyor module 4 may comprise a height adjustment assembly 62 that extends from the transportation line 16 to the floor. The height adjustment assembly 62 comprises two rods 64 that are designed to be telescoped to adjust the height of the transportation line 16 of the transportable conveyor module 4. After adjusting the height of the transportation 16 of the transportable conveyor module 4 the height can be fixed with a fastener 66. The height adjustment assembly 62 comprises supports 68 that are attached to the wheel frame 70 where the wheels 36 are attached.

The transportable conveyor module 4 further comprises an inclination adjustment device 72 that is attached to the height adjustment assembly 62 with another fastener 66 to adjust the inclination of the transportation line 16. The inclination adjustment device 72 may be a joint 74 that can be used to tilt the transportation line 16 around the axis 30 perpendicular to the direction of transportation 28.

The transportable scanning module 6 also comprises wheels 36, in particular with brakes 38. The wheels 36 may be used for moving the transportable scanning module 6. It comprises a transportation line 16 with rolls 18 for the transportation of the storage bin 22. In this embodiment, the drive assembly 76 comprises the rolls 18. The drive assembly 76 and/or part of the drive assembly 76, for example a control box and/or a box housing electrical components of the drive assembly 76, may also be attached to a frame 77 analogue to the frame 14 on the borders 20 of the transportation line 16. The transportable scanning module 6 comprises a data interface 78 that connects to a matching data interface of the automated warehouse 10. The transportable scanning module 6 further comprises a label scanner 80 that may be placed directly above a storage bin 22 passing through the transportable scanning module 6. The label scanner 80 may also be attached above the storage bin feeding port 12 of the automated warehouse 10 to scan a unique identifier on the bin 22.

The modules of the modular warehouse installation device 1 comprising the wheels 36 may be configured as carts 81 that can be pushed around. The modules can be outfitted with drive assemblies 76 to control the movements of the carts 81 and drive them.

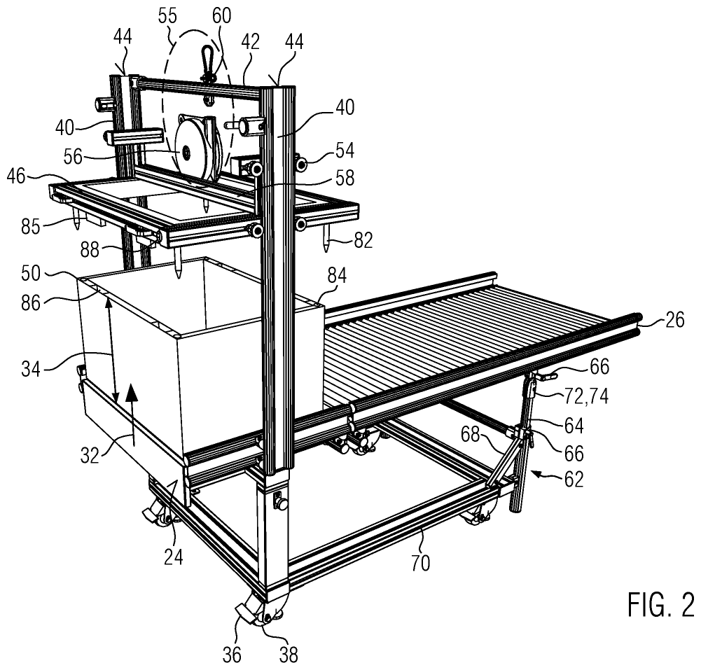

FIG. 2 shows the transportable testing gauge module 2 with details of the gauge 46. The gauge 46 comprises pins 82 that are designed to be inserted into pockets 84 of the storage bin 22 that are located on the corners of the storage bin 22 to ensure the correct placement of the bin 22 under the gauge 46 and to correctly gauge the bin 22.

The gauge 46 may further comprise complementary protruding elements 85 on the side facing the edge 50 of the storage bin 22 that are inserted into the slots 86 of the storage bin 22 when gauging. The slots 86 are the connecting element for the automated warehouse 10 to interact with the storage bin 22, so the dimensions and the spacing of the slots 86 need to be accurate.

The gauge 46 may further generate a gauge signal 88 when gauging a storage bin 22. The gauge signal 88 may be visual, acoustic and/or an electronic signal when the gauge 46 does not match the edge 50 of the storage bin 22. The gauge signal 88 may also be a visual discrepancy that the user 48 may perceive, when the gauge 46 and the bin 22 discernibly do not fit. The gauge signal 88 may also be a tactile feedback, i.e. when the frame 14 with the gauge 46 cannot be fully lowered to the edge 50 of the bin 22. The gauge signal 88 may be indicated via lamps or sounds. The lamps or sounds may be attached to the gauge 46 facing the user 48. The height 34 and/or the height conformity of the storage bin 22 may be indicated during lowering with different colors on a scale that are made visible.

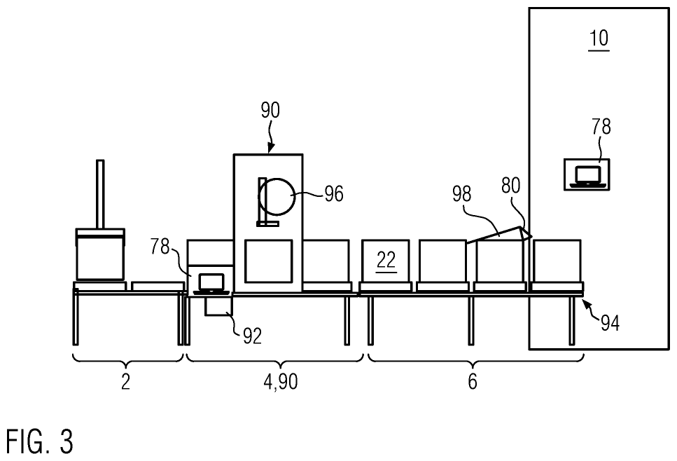

FIG. 3 shows an embodiment of the modular warehouse installation device 1 arranged in the following order: first, the transportable testing gauge module 2, second, the transportable conveyor module 4 with a labelling module 90 and third, the transportable scanning module 6 that is connected to the automated warehouse 10.

In this embodiment, the transportation lines 16 of the shown modules are flush and level. They may be driven by a drive assembly 76. The transportable testing gauge module 2 is shown with the gauge 46 that is pulled down to the storage bin 22. After the storage bin 22 has been gauged, it is transported to the transportable conveyor module 4, which has a labelling module 90 mounted on it. The transportable conveyor module 4 may comprise a control unit 92 that is connected to a data interface 78 that connects to a matching data interface 78 of the automated warehouse 10 to control the drive assembly 76, for example the speed of filling the automated warehouse 10 with the storage bins 22, particularly moving a storage bin 22 from the transportation line 16 to an internal conveying system 94 of the automated warehouse 10. The transportable conveyor module 4 may then be used as a temporary storage area for storing the storage bins 22 between gauging and scanning or between any of the modules used in the modular warehouse installation device 1.

The labelling module 90 is located between the proximal end 24 and the distal end 26 of the transportation line 16 of the transportable conveyor module 4. The labelling module 90 comprises a labelling assembly 96 that is configured to label a storage bin 22. The labelling may be a printed label or an engraving with laser. The labelling assembly 96 may be located above the storage bin 22 to be labelled.

After the labelling is done, the storage bin 22 is further transported to the transportable scanning module 6, which also comprises a transportation line 16 in this embodiment. The transportable scanning module 6 is shown with a label scanner 80, which is attached to the automated warehouse 10 above the storage bin feeding port 12. The label scanner 80 is shown to have a field of view 98 to capture the unique identifier of the storage bin 22. The transportable scanning module 6 is then configured to output an identification signal dependent on the unique identifier, i.e. a label, which can be transmitted to the internal data interface 78 of the automated warehouse 10.

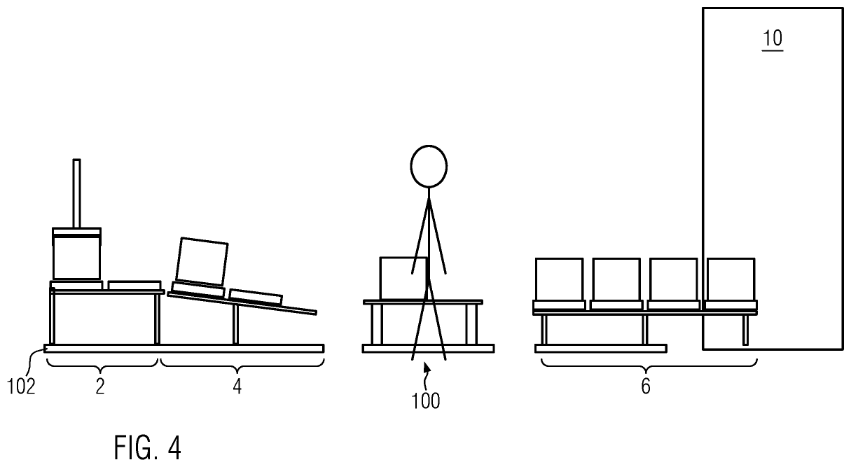

FIG. 4 shows the modular warehouse installation device 1 with a transportable testing gauge module 2 and a transportable conveyor module 4 located apart from the transportable scanning module 6 with no direct transportation line between the transportable testing gauge module 2 and the transportable scanning module 6. This embodiment is advantageous for separating the gauging task and the scanning task when it is deemed necessary due to space or logistic issues. The gauging task may be done at an entirely different location, before moving the storage bins 22 to the transportable scanning module 6 that is attached to the automated warehouse 10. The modular warehouse installation device 1 may then comprise a buffer area 100 that is placed at a location between the transportable testing gauge module 2 and the transportable scanning module 6.

The transportable conveyor module 4 follows and is directly attached to the transportable testing gauge module 2 in the direction of transportation 28. The transportation line 16 of the transportable conveyor module 4 is tilted, so that the proximal end 24 of the transportation line 16 is higher than the distal end 26 of the transportation line 16. In this way, the storage bin 22 may be transported from the transportable testing gauge module 2 from the proximal end 24 of the transportation line 16 to the distal end 26 without a drive assembly and only with gravitational force. The proximal end 24 can be configured and tilted in a way that the proximal end 24 is flush with the transportation line 16 of the transportable testing gauge module 2. The proximal end 24 is especially flush with the distal end 26 of the transportation 16 of the transportable testing gauge module 2, providing a seamless transport from the transportable testing gauge module 2 to the transportable conveyor module 4.

The individual modules each may further comprise a pedestal 102, which is located directly under the modules, as depicted in FIG. 4 on the modules 2, 4, and 6, as well as on buffer area 100. The pedestal 102 may be used to lift the modules with a forklift vehicle for ease of transportation.

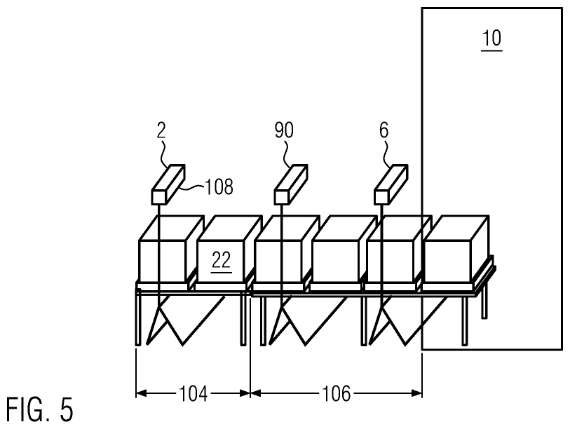

In FIG. 5 the modular warehouse installation device 1 is shown with the transportation line 16 that is connected to the automated warehouse 10. In this embodiment the transportable testing gauge module 2, the labelling module 90 and the transportable scanning module 6 are configured to be placed next to the transportation line 16 on one side of the at least one transportable conveyor module 4. In particular, the modules may be placed on one of the two sides facing the direction 30 perpendicular to the direction of transportation 28. The modules may also be placed in front of a transportation line 16, at the side facing the opposite direction of transportation 28, where the user 48 would normally access the start of the transportation line 16. This way, the modularity and transportability of the modular warehouse installation device 1 is increased.

In this embodiment, the modular warehouse installation device 1 comprises at least two transportable conveyor modules 4, where the distance 104 between the proximal end 24 and the distal end 26 of the one transportable conveyor module 4 is different from the distance 106 between the proximal end 24 and the distal end 26 of the other transportable conveyor module 4. The distances 104, 106 may be adjustable, designed to be telescoped or with insertable sections.

In an alternative embodiment, the transportable testing gauge module 2 may comprise a camera 108 with an image processing device that determines the deviation of the shape of the bin 22. The transportable testing gauge device 2 may then comprise a data interface 78 that is connected to the camera 108 and to a matching data interface 78 of the automated warehouse 10 to transmit the gauge signal 88 and/or height 34 of the storage bin 22 to the matching data interface 78 of the automated warehouse 10. The image processing device may be a software or hardware and may be part of the control unit 92 of the transportable testing gauge module 2. The image processing device may also be part of the automated warehouse. The data processing may be done within the data interface 78. The data processing may also be done at the matching data interface 78 of the automated warehouse 10, wherein the camera 108 sends raw images to the automated warehouse 10 for processing. This can be fully automated as well.

The individual modules can be assembled in any order and provide full flexibility in adjusting to the needs of the individual installations and bin filling processes.

### REFERENCE NUMERALS

1 modular warehouse installation device
2 transportable testing gauge module
3 testing assembly
4 transportable conveyor module
6 transportable scanning module
8 distal end of the transportable scanning module
9 mechanical interface
10 automated warehouse
12 storage bin feeding port of the automated warehouse
14 frame
16 transportation line
18 roll
20 border
22 storage bin
24 proximal end
26 distal end
28 direction of transportation
30 direction perpendicular to the direction of transportation
32 direction of the raised border
34 height of the storage bin
36 wheels
38 brake
40 beam of the frame
42 connecting bar of the frame
44 upper end of a beam
46 gauge
48 user
50 edge of the storage bin
52 U-shaped element of the gauge
54 sliding roll of the gauge
55 lifting assembly
56 lifting element
58 support section of the gauge
60 stationary element of the lifting assembly
62 height adjustment assembly
64 rod of height adjustment assembly
66 fastener
68 support of height adjustment assembly
70 wheel frame
72 inclination adjustment device
74 joint
76 drive assembly
77 frame of the scanning module
78 data interface
80 label scanner
81 cart
82 pin of the gauge
84 pocket of the storage bin
85 complementary protruding element of the gauge
86 slot of the storage bin
88 gauge signal
90 labelling module
92 control unit
94 internal conveying system of the automated warehouse
96 labelling assembly
98 field of view
100 buffer area
102 pedestal
104 distance between proximal end and distal end
106 distance between proximal end and distal end
108 camera

1. A modular warehouse installation device for initial filling of an automated warehouse with a plurality of storage bins, wherein the modular warehouse installation device comprises a plurality of transportable modules comprising:
a transportable testing gauge module comprising a testing assembly that is configured to:
determine a deviation of a shape of any storage bin of the plurality of storage bins from a predetermined standard shape; and
generate a gauge signal dependent on the determined deviation; and
a transportable scanning module comprising a label scanner, the label scanner having a field of view and being configured to output an identification signal dependent on a label in the field of view and located on any storage bin of the plurality of storage bins, wherein the plurality of transportable modules are configured to be assembled in any order.

2. The modular warehouse installation device according to claim 1, comprising:
a at least one transportable conveyor module comprising a transportation line, the transportation line having a distal end and a proximal end and being configured to movably support at least one storage bin of the plurality of storage bins, wherein the at least one transportable conveyor module is configured to guide the at least one storage bin from the proximal end to the distal end.

3. The modular warehouse installation device according to claim 2, wherein the at least one transportable conveyor module comprises a height adjustment assembly configured to adjust a height of the transportation line.

4. The modular warehouse installation device according to claim 2, wherein the at least one transportable conveyor module comprises an inclination adjustment device configured to adjust a height difference between the proximal end and the distal end of the transportation line.

5. The modular warehouse installation device according to claim 2, wherein the at least one transportable conveyor module comprises a drive assembly configured to move at least one of the plurality of storage bins from the proximal end to the distal end.

6. The modular warehouse installation device according to claim 5, wherein the at least one transportable conveyor module comprises a control unit, the control unit comprising a data interface that is adapted to be connected to a matching data interface of the automated warehouse and to control the drive assembly dependent on data received from the automated warehouse via the data interface.

7. The modular warehouse installation device according to claim 2, wherein the distal end is configured as a mechanical interface that connects to a storage bin feeding port of the automated warehouse for passing a storage bin from the transportation line to an internal conveying system of the automated warehouse.

8. The modular warehouse installation device according to claim 1, wherein the transportable testing gauge module comprises a transportation line being configured to movably support at least one storage bin of the plurality of storage bins.

9. The modular warehouse installation device according to claim 8, wherein the testing assembly comprises:
a lifting assembly;
a frame; and
a gauge mounted to the frame, the lifting assembly being configured to lower the frame onto a storage bin on the transportation line of the transportable testing gauge module, and the gauge signal being dependent on a lowered position of the frame.

10. The modular warehouse installation device according to claim 1, wherein the transportable testing gauge module is configured to determine a height of a storage bin.

11. The modular warehouse installation device according to claim 1, wherein the transportable scanning module comprises a data interface that is adapted to be connected to a matching data interface of the automated warehouse and to transmit data representative of a scanned label via the matching data interface to the automated warehouse.

12. The modular warehouse installation device according to claim 1, wherein the transportable scanning module comprises a transportation line being configured to movably support at least one storage bin of the plurality of storage bins.

13. The modular warehouse installation device according to claim 1, wherein the plurality of transportable modules comprises at least two transportable conveyor modules wherein a first distance, between a distal end and a proximal end of a first module of the at least two transportable conveyor modules is different from a second distance between a distal end and a proximal end of a second module of the at least two transportable conveyor modules.

14. The modular warehouse installation device according to claim 1, wherein the plurality of transportable modules further comprise:
a labelling module which comprises a labelling assembly configured to label a storage bin.

15. The modular warehouse installation device according to claim 1, wherein the plurality of transportable modules are configured as carts.
